(19) United States
(12) Patent Application Publication
(10) Pub. No.: US 2009/0071048 A1
(43) Pub. Date: Mar. 19, 2009

(54) Multiple static image display

(76) Inventor: Yi Lan, Shenzhen City (CN)

Correspondence Address: DEAN A. CRAINE;SUITE 140, 400 - 112TH AVENUE NE, BELLEVUE, WA, 98004, US

(21) Appl. No.: 12/215,380

(22) Filed: Jun. 25, 2008

Related U.S. Application Data
(60) Provisional application No. 60/937,254, filed on Jun. 25, 2007.

(51) Int. Cl. G09F 19/02

(52) U.S. Cl. 40/437

(57) ABSTRACT

A multiple static image display that can be used as a large sign in public areas, such as airports and shopping malls that present the images with a relatively short or non existing transitional period. The sign includes a light box with a plurality of light bulbs mounted therein. Located in front of the light bulbs is a moving, transparent image panel with a transparent image film temporarily mounted thereon. Formed on the image film are at least two offset images. Located in front of the image panel is a fixed screening panel that includes a checkerboard-like mesh surface made up of a plurality of clear, transparent squares or holes evenly spaces apart thereon within a black, opaque background. The images on the image film are offset a distance slightly greater than ½ the distance of the black dot. When the image panel is moved approximately ½ black dot distance different images can be seen when viewing the display from the front. Because the amount of movement is relatively small, no transitional period between images is received.

This is a utility patent application which claims benefit of U.S. Provisional Application No. 60/937,254 filed on Jun. 25, 2007.

### BACKGROUND OF THE INVENTION

1. Field of the Invention

This invention pertains to image displays, and more particularly to image displays designed to continuously show multiple, static images in a slide show manner.

2. Description of the Related Art

Advertising displays and signs that show different static images or photographs are very common in airports and shopping malls. Such displays and signs typically include a projector and carousel with photograph slides mounted therein that are continuously exchanged after a few seconds. Unfortunately, a relatively long transitional period, normally seen as a black screen, is created each time the photographic slides are exchanged.

Computers typically include image slide presentation software programs or ‘screen saver’ software program that can present a slide show of different digital images saved in a digital file on the computer. The images may be presented on the display for a few seconds and then replaced by another image that slides onto the display. Alternatively, the images may be individually presented by gradual exploding and fading action. In each instance, brief transitional black screens are created between images.

Large displays and signs that can present a slide show of images in a visual manner similar to a ‘screen saver’ program on a computer display that can be used in public areas, such as airports and shopping malls with no or relatively short transitional phrases between images would be highly desirable. While such signs could be made by coupling a large flat screen LCD or plasma to a computer, such signs are expensive and can be easily vandalized.

What is needed is a display that presents a slide show of images in a novel, captivity manner without creating a transitional period that is relatively inexpensive to manufacture, and less likely to be vandalized.

### SUMMARY OF THE INVENTION

It is an object of the present invention to provide a slide show advertising display or sign.

It is another object of the present invention to provide such a display with no transitional period between images so that the images blend smoothly together.

It is another object of the present invention to provide such a sign display that can be used in large public areas.

These and other objects are met by a multiple image slide show display disclosed therein that can be used as a large display sign in public areas, such as airports and shopping malls that exchange images with no transitional period there between. The display includes a light box with a light source mounted therein. Located in front of the light source is a moving, transparent image panel with a transparent image film temporarily mounted thereon. Located in front of the image panel is a fixed screening panel that includes a checkerboard-like mesh printed surface made up of a plurality of clear, transparent squares or holes evenly spaced apart on black areas. Formed on the image film is two or three offset images which when aligned with the clear holes on the screening panel become visible when standing in front of the display. The images on the image film are slightly offset from each other so that when the image panel is moved in a straight line along a designated an axis, one of the images on the image film is visible through the clear holes while other images are blocked by the black areas. During operation, the image panel moves back and forth inside the light box to individually preset the three images.

In the preferred embodiment, the light source is mounted behind the image panel is a plurality of equally spaced apart lamps. Also included is an image panel adjustment mechanism that allows the operator to adjust the position of the image panel with respect to the screening panel so that all of the images can be seen clearly when standing in front of the display.

### DESCRIPTION OF THE DRAWINGS

FIGS. 1A-1C is sequential front elevational views of the display showing three different images being presented consecutively.

FIG. 2 is a front elevational view of the display.

FIG. 3 is a side elevational view of the display.

FIG. 4 is a top plan view of the display.

FIG. 5 is an exploded perspective view of the display showing the relative locations of the image panel, image film and screening panel mounted in the rigid light box.

FIG. 6 is an illustration of a section of the screening panel showing the clear boxes evenly distributed in the black background.

FIG. 7 is an illustration of a section of the image panel showing the relative locations of three images represented by three unique shaded squares on the image panel.

FIG. 8 is a front elevational of the light box showing the relative locations of the lamps.

FIG. 9 is a partial front elevational view of the lower right-hand corner of the display with the image panel, the image film and the screening panel partial removed.

FIG. 10 is partial, sectional elevational view taken along line 10-10 shown in FIG. 9.

FIG. 11 is a partial, side elevational view of the light box showing an electric motor mounted on one side of the image panel used to move the image panel back and forth lateral.

FIG. 12 is a top plan view of a cam disc attached to the electric motor which, when rotated, slowly forces the image panel back and forth laterally.

### DESCRIPTION OF THE PREFERRED EMBODIMENT(S)

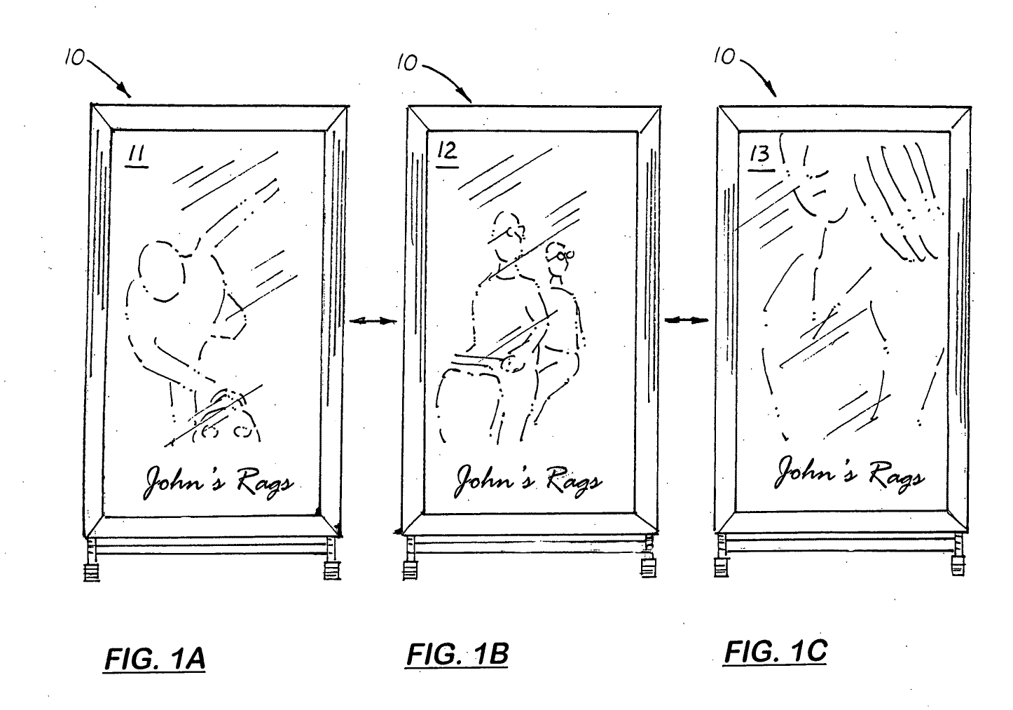

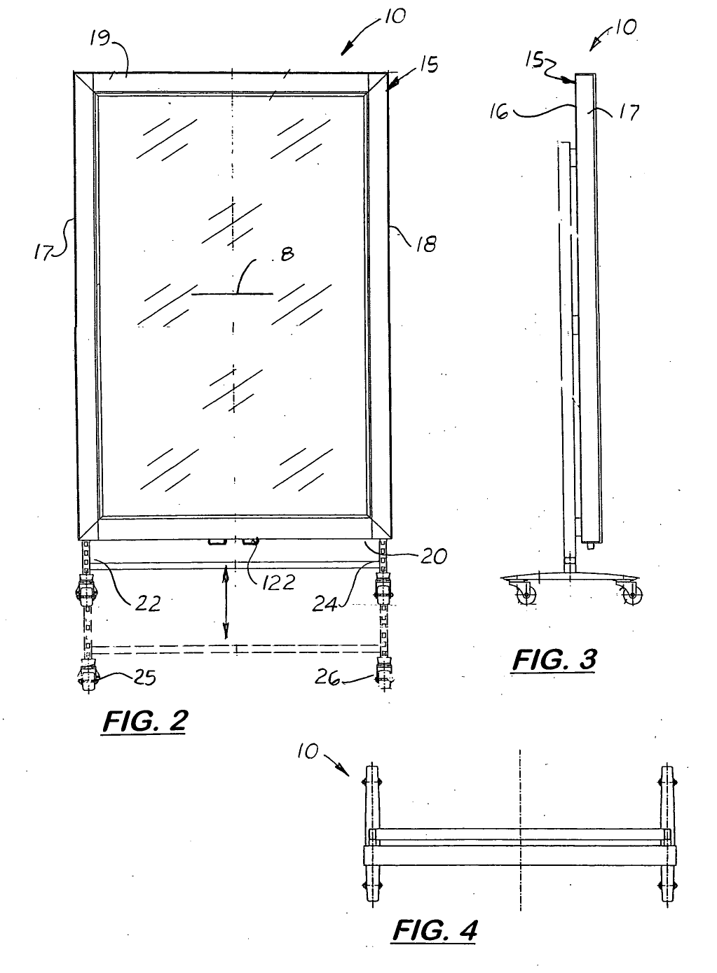

Referring to the Figs. there is shown a multiple image slide show display 10 disclosed therein that can be used as a large sign in public areas, such as airports and shopping malls that present two or three different images 11, 12, 13 (See FIGS. 1A, 1B, and 1C) with no transitional period formed between them thereby simulating a ‘screen saver’ on a computer display.

The display 10 includes a rigid light box 15 with a plurality of tubular florescent light bulbs 60 mounted therein. The light box 15 includes a closed rear wall 16, two side walls 17, 18, a top wall 19 and a bottom wall 20. In the preferred embodiment, the light box 15 is mounted on two legs 22, 24. Caster wheels 25, 26 are attached to the legs 22, 24. The front area of the light box 15 is open.

Located inside the light box 15 is a complementary-shaped image panel 30. The image panel 30 is disposed directly in front of the light bulbs 60 and is slightly smaller in width so that it may move back and forth along a designated axis 16 inside the light box 15. In the preferred embodiment, the image panel 30 is connected to a small electric motor 35 disposed between the sides of the light box 15 and the image panel 30 that moves the image panel 30 laterally back and forth along the designated axis 16. The image panel 30 is made of rigid glass or plastic and is transparent so that light from the light bulbs 60 may pass through.

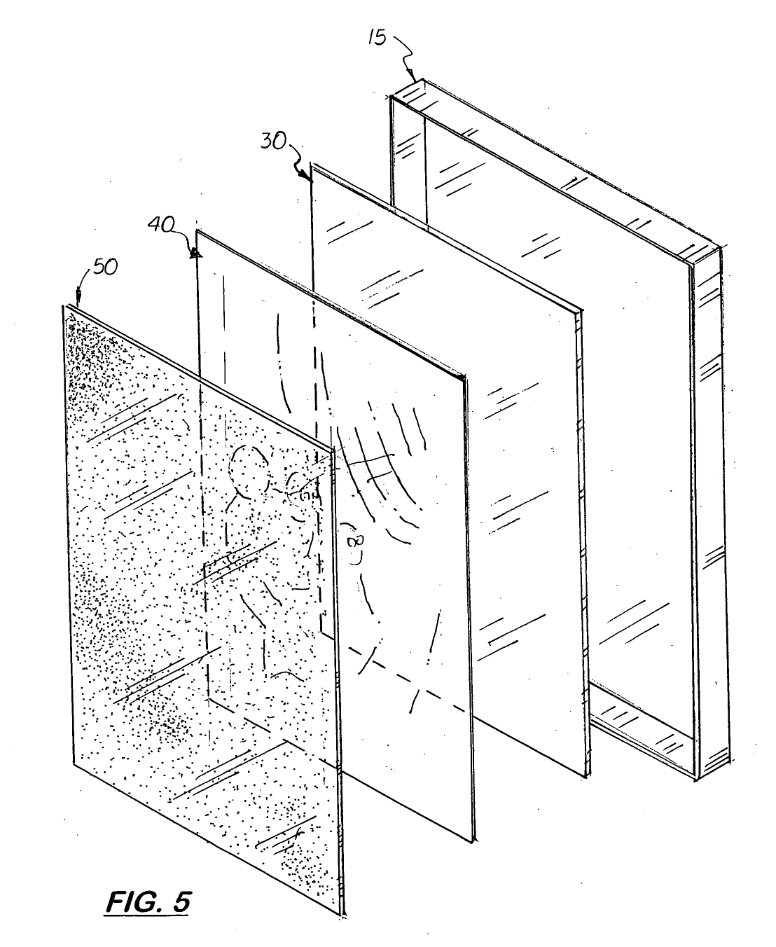

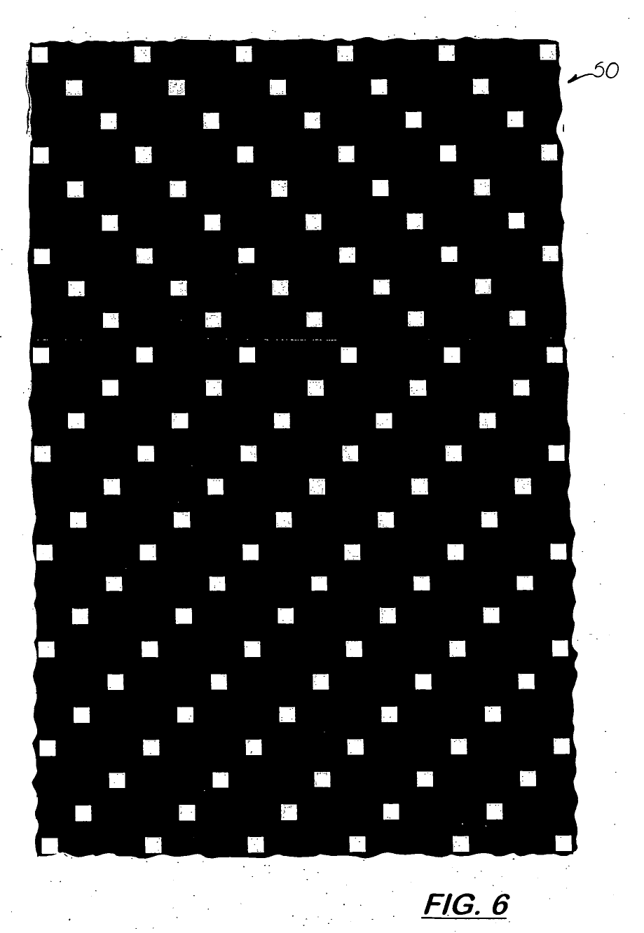

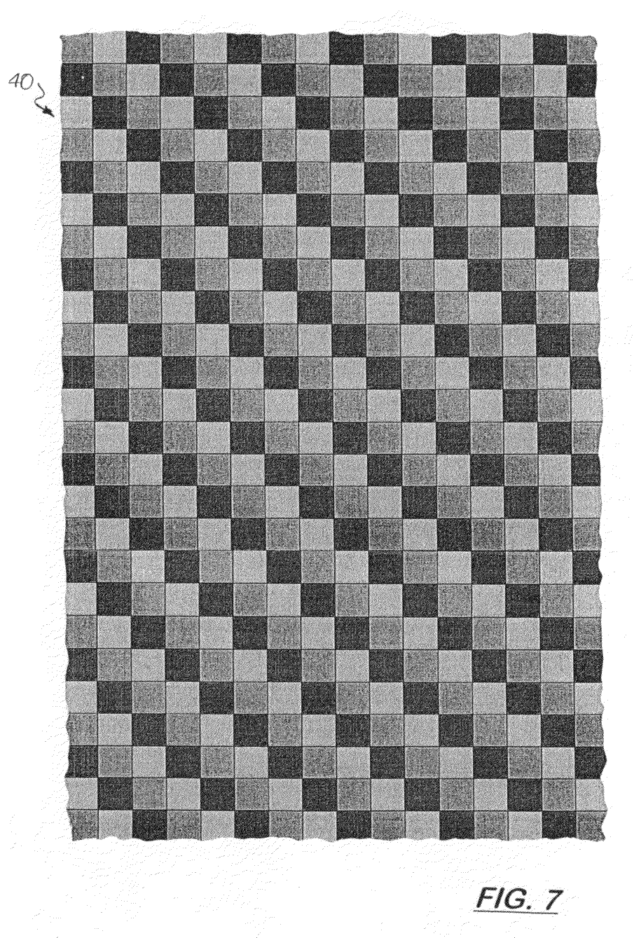

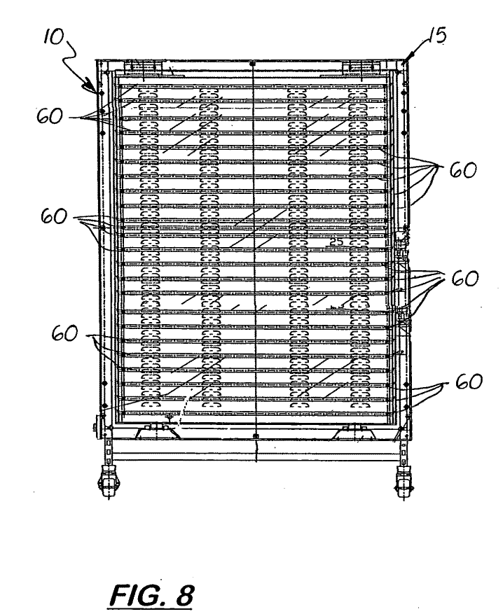

Located in front of the image panel 30 and inside the light box 15 is a fixed screening panel 50. The screening panel 50 includes a checkerboard-like surface 52 printed or formed thereon made up of a plurality horizontal and vertical rows 53a, 53b each made of the alternating transparent or clear holes 54 and black areas 56. In the preferred embodiment, the holes 54 and black areas 56 are uniform size and equally spaced apart. (See FIG. 5). During assembly, the screen panel 50 is aligned and stacked in front of the image panel 30 and a small gap 58 is created between them so that the image panel 30 can slide freely behind the screening panel 50. The screening panel 50 is designed to fit inside the light box 15 and has a length dimension slightly less than the image panel 30. Inward extending clips 59 are used to hold the screening panel 50 in place inside the light box 15. In the preferred embodiment, the screening panel 50 is made of glass or plastic material.

Adhesively attached to the front surface of the image panel 30 is a transparent image film 40. The image film 40 is designed to be selectively replaced and may be held in place along its perimeter edges to the image panel 30 with adhesive tape (not shown). The image film 40 includes at least two or three offset images 11, 12, 13 which are designed to be individually and consecutively shown to a viewer standing in front of the display 10. In the preferred embodiment, the images 11, 12, 13 on the image film 40 are offset along an axis parallel to the image panel's axis of movement. In the accompanying Figs, the image panel's axis of movement is parallel to the designated axis 16. The first image 11 is seen when all or a sufficient number of the dots that make up the image are aligned with the clear holes 54. The remaining images 12, 13 are obscured by the surrounding black areas 55. When the second image 12 is to be displayed, the image panel 30 is moved the laterally along the designated axis until the dots that make up the second image is visible through the clear holes 24. The dots that make up the first and third images 11, 13 are now obscured by the black areas 55. When the third image 13 is to be displayed, the image panel 30 is moved the laterally along the designated axis 16 until the dots that make up the third image 13 is visible through the clear holes 24. The dots that make up the first and second images are now obscured by the black areas 55. The display panel 10 is designed so that the image panel 30 moves back and forth inside the light box 15 so that the images 11, 12, 13 are presented repeatedly in the following manner: first image 11, second image 12, third image 13, second image 12, first image 11 and repeated. In the preferred embodiment, the electric motor 120 used to control the movement of the image screen operates at a constant speed so that the images 11, 12, 13 are quickly exchanged at the same rate and exposed for the same length of time.

To the viewer, each clear hole 54 presents a dot size area of the underlining image. Depending on the nature of the images used on the image screen 30, each clear hole 54 may change or remain the same color or shading. Some instances where the images contains sections made up of dots having the same color, the clear holes 54 may not appear to undergo a change when the images changes.

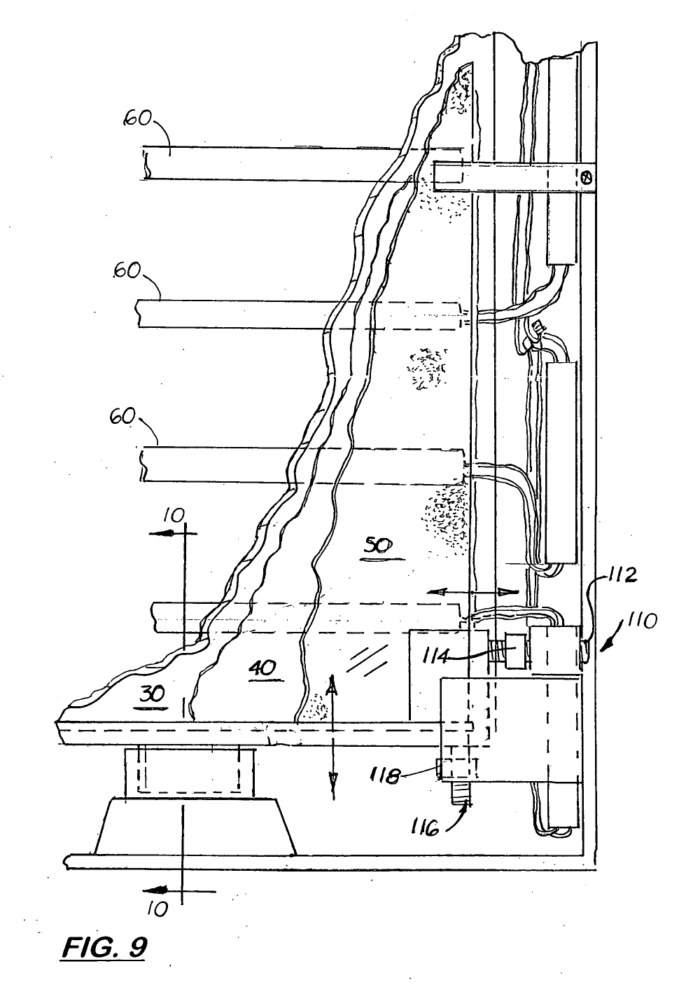

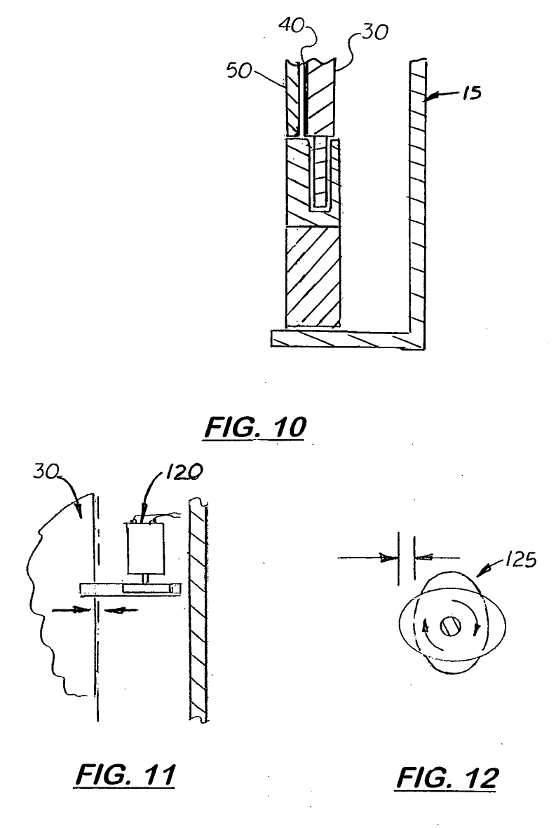

FIG. 9 is a partial front elevational view of the lower right hand corner of the display 10 showing the screening panel 50 and the image film 40 removed. Formed on the bottom end surface of the light box 15 are two evenly spaced track supports 70, 75 designed to align and hold the screen panel 50 and the image panel 30 at a constant elevation inside the light box 15. Attached to the lower edge of the image panel 30 is a downward extending guide tab 80 which engages a track member 72 attached to the top surface of the track support 70. FIG. 10 is a side elevational view of the image panel and track member 72 taken alone line 10-10 in FIG. 9. The track member 72 is a U-shaped structure with a center slot 73. During assembly, the guide tab 80 slides freely inside the slot 73.

Also shown in FIG. 9, is an image panel adjustment mechanism 110 located at each corner that enables the corner of the image panel 30 to be vertically and horizontally adjusted inside the light box 15. Each adjustment mechanism includes two adjustment bolts 112, 116 and two nuts 114, 118 which are rotated to force the image panel 30 horizontally and vertically with respect to the screening panel 50. During setup, the screening panel 50 is first removed from the light box 15. Then the image film 40 is adhesively attached to the front surface of the image panel 30. The screening panel 50 is then re-attached to the light box 15. Next, the image panel 30 is adjusted with respect to the screening panel 50 via the adjustment mechanism 110 located at each corner until all of the images 11, 12, 13 printed on the image film 40 can be seen through the screen panel 50 when the image panel 30 is moved back and forth.

FIG. 11 is a partial, side elevational view of the light box 15 showing an electric motor mounted 120 on one side of the light box 15. The electric motor 120 is electrically connected to a manual switch 122 attached to the bottom surface 20 of the light box 15. Attached to a drive shaft 124 on the motor is a oval-shaped cam 126 which, when rotated, causes the image panel 30 back and forth laterally across three clear holes 54.

In the preferred embodiment a decorative frame 60 is mounted over the front edges of the light box 15 and the perimeter edges of the two panels 30, 50. The display 10 can be manufactured in different sizes and shapes and mounted on legs 22, 24 and caster wheels 25, 26 or mounted directly on a support surface. In the embodiment shown in the accompanying Figs., the display 10 measures approximately 60 inches in height, 48 inches in length, and five inches in depth and includes 22×40 watt fluorescent light bulbs. The image screen 30 is slightly smaller then the rigid box 15. The screen panel 50 is sufficiently small so that it may move back and forth inside the rigid box 15. In the preferred embodiment, three images 11, 12, 13 are used which are offset along the axis that parallel to the axis of movement for the image panel 30. In the preferred embodiment, the clear holes 54 and the adjacent black areas 55 are approximately 3 mm (+/−0.25 mm) in length. By way of examples, the three images 11, 12, 13 are offset 3 mm (+/−0.25 mm). It should be understood however, that the images 11, 12, 13 simply overlap so that dots on one image may be used on the second or third image.

The above described display 10 presents the static images in a unique manner that makes the display an effective, captivating advertising structure. Because the clear holes 54 and black area 55 are relatively small, the color of the dots can be change quickly so that the transition period between images is substantially reduces or eliminated. Also, because some clear holes 54 do not undergo any change in color or shading, only some sections of the image appears to undergo change. Also, because the electric motor operates at a continuous speed, the images are changed in a hypnotic manner. These three aspects all contribute to make the display captivating to viewers.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A multiple static image display, comprising:
a. light box with a front opening;
b. a light source mounted inside said light box;
c. a transparent image panel mounted inside said light box and in front of said light source;
d. at least two offset images mounted on said image panel, said images being offset a known distance;
e. means for moving said image panel back and forth along at least one axis of said light box; and,
f. a fixed screening panel located inside said light box, said screening panel includes a checkerboard-like surface made up of a plurality of alternating rows each made up of alternating transparent, clear holes and black areas evenly spaced apart, said clear holes and said black areas being sufficient in size so that when said image panel is moved back and forth along a designed axis, said images are individually presented and the other image is obscure.

2. The display, as recited in claim 1, where in said light source is a plurality of light tubes located inside said light box.

3. The display, as recited in claim 2, wherein said light tubes are fluorescent lights.

4. The display, as recited in claim 1, wherein said means for moving said image panel is an electric motor disposed between said image panel and said light box.

5. The display, as recited in claim 1, wherein said images are printed on image film attached to said image panel.

6. Multiple static image display, comprising:
a. a light box that includes a front opening;
b. a light source mounted inside said light box;
c. an image panel located inside said light box and in front of said light source, said image panel includes at least two static images mounted thereon;
d. means for moving said image panel back and forth in a straight line within said light box; and,
e. a screen panel located in front of said image panel, said screen panel includes a checkerboard surface including alternating rows each made of alternating evenly spaced apart transparent clear holes and black areas, wherein the size and shape of said holes and black areas than the location of said images on said image panel being offset so that the display is assembled and means for moving said image panel is activated, the image panel moves back and forth behind said screen panel so that the images are repeatedly shown individually and consecutively.

7. The display, as shown in claim 6, wherein said image panel includes three offset images and said means for moving said image panel moves said image panel sufficient distance so that there images are repeatedly shown individually and consecutively.

8. The display, as shown in claim 6, further including means for adjusting the relative location of said image panel inside said light box.

9. The display, as shown in claim 6, wherein said light source is a plurality of lamps located inside said light box.

10. The display, as recited in claim 6, further including a switch mounted on said light box and connected to said light source.

11. The display, as recited in claim 6, wherein said means for moving said image panel back and forth in a straight line within said light box is an electric motor coupled to a track.

12. The display, as recited in claim 6, further including a switch mounted on said light box and connected to said electric motor.
